(19) United States
(12) Patent Application Publication
(10) Pub. No.: US 2006/0156550 A1
(43) Pub. Date: Jul. 20, 2006

(54) Shaver, shaving head and method of cleaning a hair chamber of a shaver

(75) Inventors: Johannes Beugels, Drachten (NL); Sint Baron, Drachten (NL); Jascha Van Pommeren, Drachten (NL); Bas Hamer, Groningen (NL)

Correspondence Address: PHILIPS INTELLECTUAL PROPERTY & STANDARDS, P.O. BOX 3001, BRIARCLIFF MANOR, NY, 10510, US

(73) Assignee: koninkjkle phillips electronics n.v.

(21) Appl. No.: 10/562,289

(22) PCT Filed: Jun. 24, 2004
(86) PCT No.: PCT/IB04/50989

§ 371 Date: Dec. 22, 2005

(51) Int. Cl. B26B 19/28

(52) U.S. Cl. 30/45

(57) ABSTRACT

A shaver comprises a shaving head (4; 104) with a screen (6) having an internal surface (7), an external surface for contacting a skin to be shaved, and hair-receiving openings (8, 9), and a cutter (3) having at least one cutting edge (5) movable along the internal surface (7) of the screen (6) by means of a drive structure (44; 125) that includes a motor. The cutting edge (5) cooperates with the screen (6) for cutting off hairs projecting through the hair-receiving openings. Behind the hair-receiving openings (8, 9) a hair chamber (13; 113; 213; 313) is located. The shaver is equipped with one or more liquid displacement impellers (15; 115; 215; 315) for displacing liquid through the hair chamber (13; 113; 213; 313). The impellers (15; 115; 215; 315) are each connected to the drive structure (44; 125) for driving the movement of the impeller (15; 115; 215; 315) for cleaning the hair chamber (13; 113; 213; 313).

This invention relates to a shaver, to a shaving head, and to a method of cleaning a hair chamber of a shaver.

A hair chamber in which cut-off whiskers, hair dust, and skin chips accumulate, is located behind a shaving head or shaving heads of a shaver with a shaving screen including hair-receiving openings and a driven cutter or driven cutters co-operating with the openings in the screen for cutting off hairs projecting through the hair-receiving openings. If the hair chamber is not cleaned regularly, an unhygienic situation arises which impairs the function of the shaver and sometimes leads to malfunction of the shaver or even damage to the shaver. Such an accumulation can and should be avoided by regular cleaning of the hair chamber, but many users find this cumbersome because it requires disassembling the shaving head or shaving head holder, or simply forget to clean the hair chamber. Shaver designs typically include special measures to make disassembling the shaving unit for gaining access to the hair chamber fairly simple, such as a quick-release connection of the shaving head holder to the housing and supports that retain various parts together when the hair chamber is open.

Various shavers are known from the prior art which include a fan for drawing air through the hair-receiving openings. For example, Japanese patent application 01-97493 discloses a shaver with an impeller for moving air and hair from behind the shaving blade to a dust collecting part where air is exhausted via a filter, U.S. Pat. No. 3,634,935 discloses a shaver with a fan and a centrifugal separator downstream of the fan for separating hair from an airflow arriving from the shaving head, U.S. Pat. No. 3,828,430 discloses a shaver with nets in front of outlet openings to avoid that hair is blown out of the shaver, U.S. Pat. No. 4,031,618 discloses a shaver with a vacuum system for drawing hairs into a cutting position and exhausting cut hair from the casing, and U.S. Pat. No. 4,089,110 discloses a shaver with a receptacle communicating with an outlet passage for collecting the cut whiskers. However, operation of such shavers is also cumbersome, because either hair collecting receptacles and filters have to be emptied and cleaned regularly, or whiskers and hair dust etc. are blown out of the housing and are distributed over a relatively large area instead of falling down, for example into a washing stand. Moreover, relatively much of the cut hair and skin is left back in the hair chamber.

It is an object of the invention to provide a solution for cleaning the hair chamber of a shaver quickly, easily and effectively.

According to the invention, this object is achieved by providing a shaver according to claim 1. The invention also provides a cleaning method according to claim 23, with which this object can be achieved.

Hair, hair dust and, where applicable, remainders of shaving lotion and the like are effectively and reliably rinsed away in that a liquid displacement is caused in the hair chamber using an impeller or impellers driven by a drive structure of the shaver. The impeller or impellers ensure a sufficiently vigorous motion of the liquid for effectively cleaning the hair chamber.

The invention can also be embodied in a shaving head according to claim 20 which is adapted for use in a shaver according to a particular embodiment of the invention in which at least one flushing passage extends through the shaving head or at least one of the shaving heads. Other particular embodiments of the invention are set forth in the dependent claims.

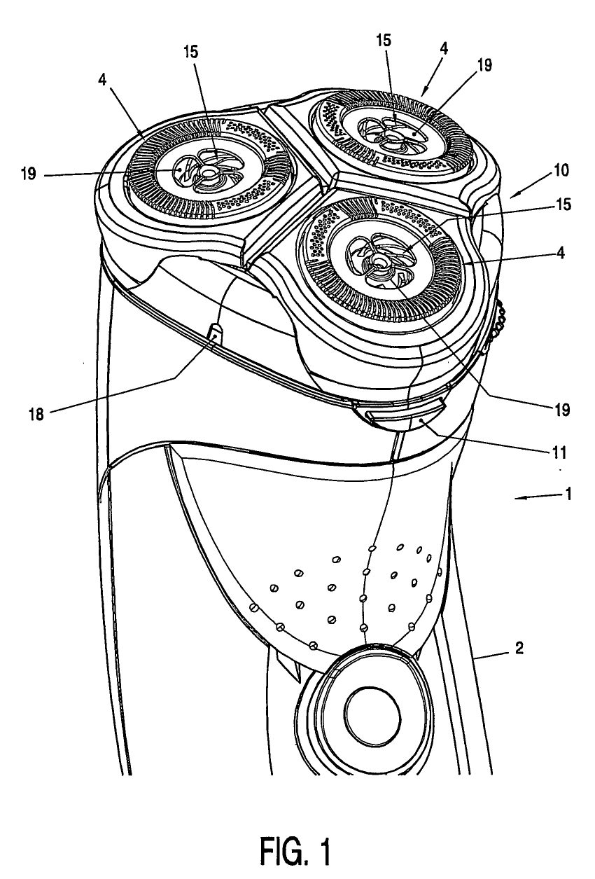

FIG. 1 is a perspective view of a top portion of a first shaver according to the invention;

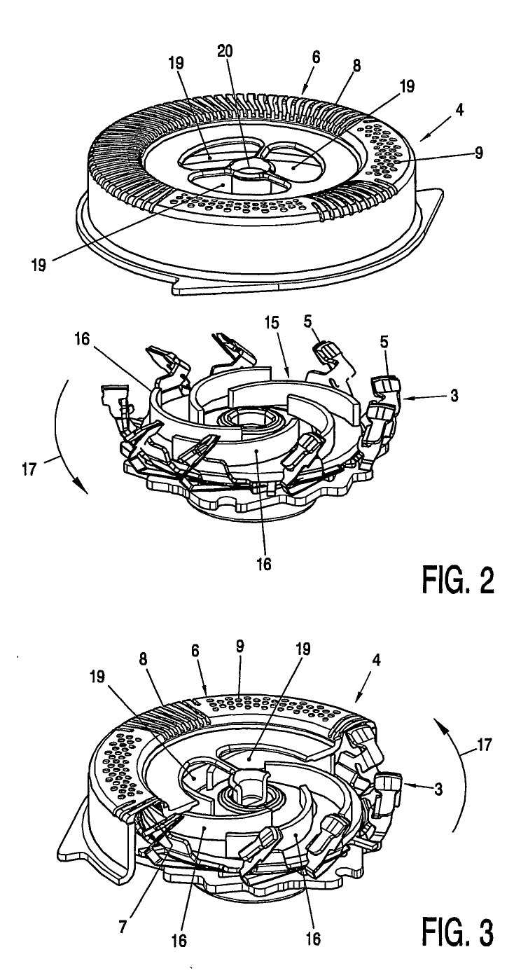

FIG. 2 is an exploded, perspective view of a shaving head of the shaver according to FIG. 1;

FIG. 3 is a cut-away, perspective view of the shaving head shown in FIG. 2;

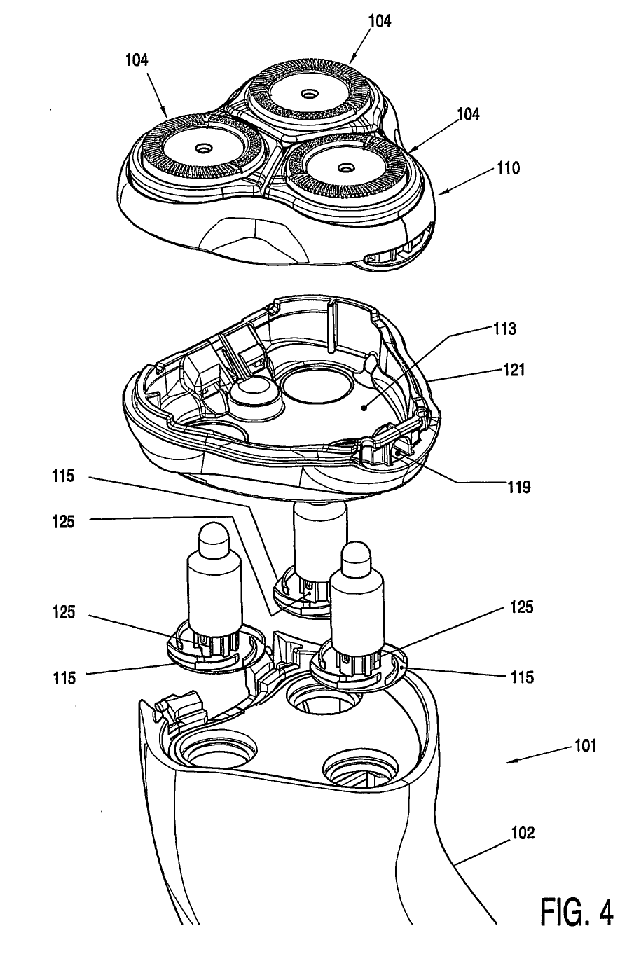

FIG. 4 is an exploded, perspective view of a top portion of a second shaver according to the invention;

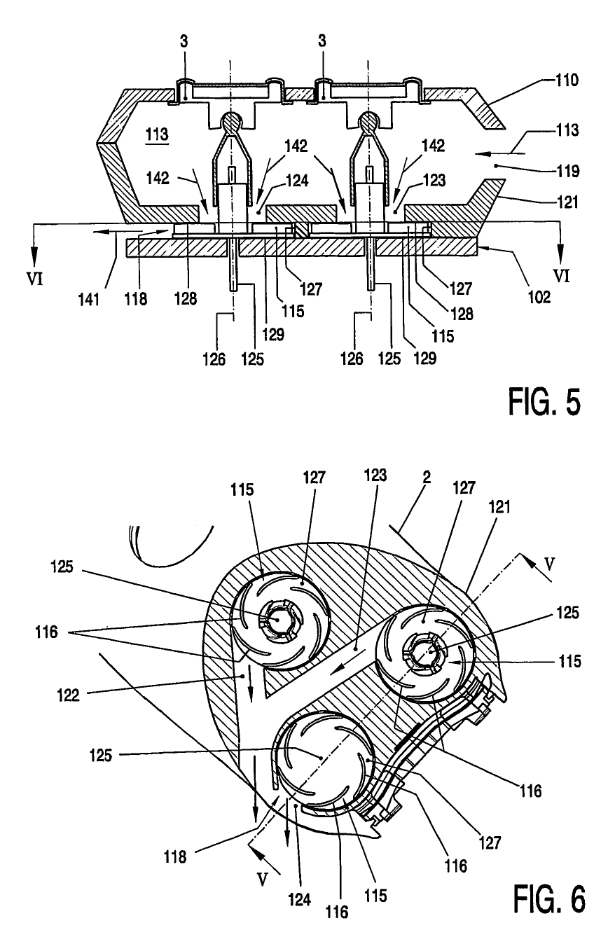

FIG. 5 is a schematic cross-sectional view taken on the line V-V in FIG. 6 of a hair chamber, a shaving head holder, shaving heads, and a housing portion of the shaver according to FIGS. 4 and 6;

FIG. 6 is a cross-sectional view taken on the line VI-VI in FIG. 5;

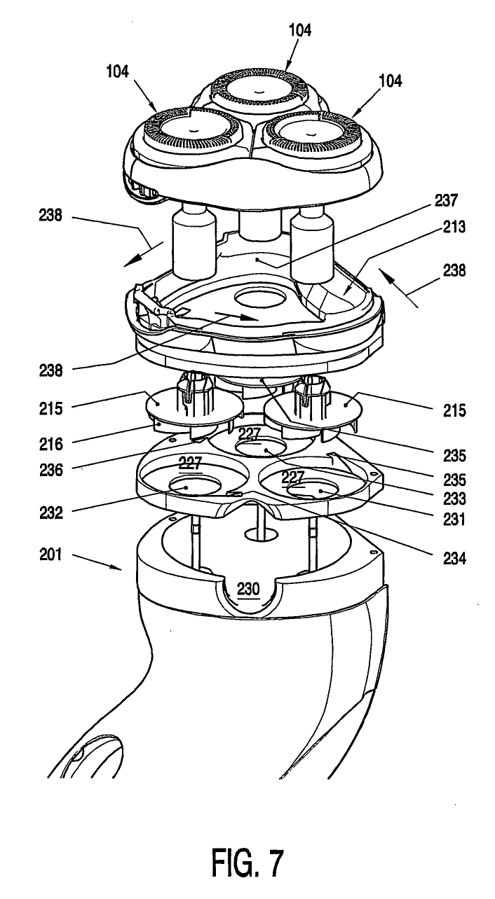

FIG. 7 is an exploded, perspective view of a top portion of a third shaver according to the invention;

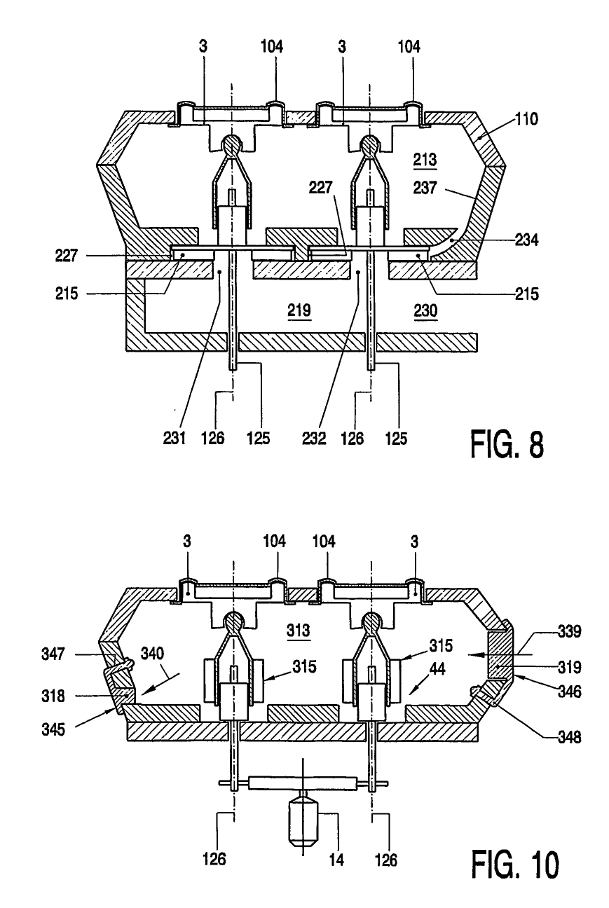

FIG. 8 is a schematic cross-sectional view of a hair chamber, a shaving head holder, shaving heads, and a housing portion of the shaver according to FIG. 7;

FIG. 9 is a perspective view of a top portion of a fourth shaver according to the invention; and

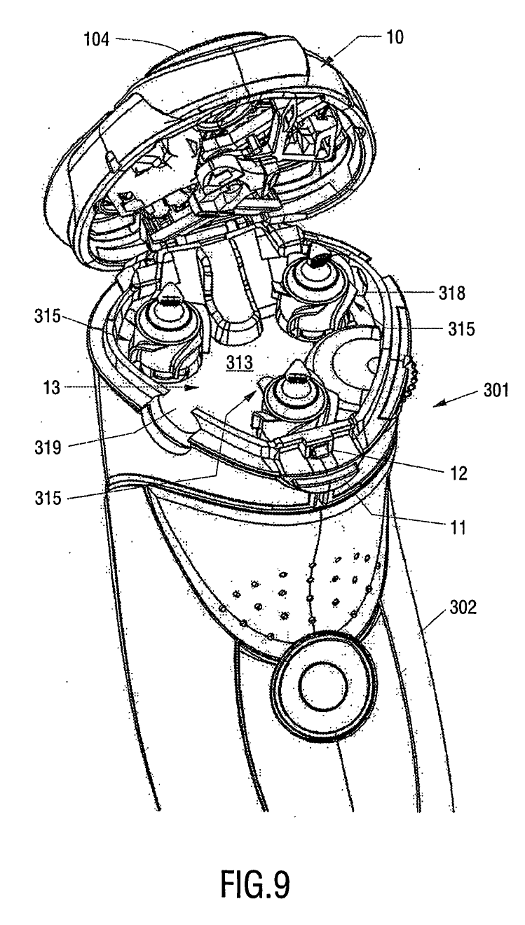

FIG. 10 is a schematic cross-sectional view of a hair chamber, a shaving head holder, shaving heads, and a housing portion of the shaver according to FIG. 9.

In the drawings, mutually identical parts of different exemplary embodiments shown are designated by mutually identical reference numerals.

FIGS. 1 to 3 show a first example of a shaver 1 according to the invention. This shaver has a housing 2 in which a motorized drive structure including a motor is accommodated. The drive structure and the motor are not visible in FIGS. 1 to 3, but the shaver shown in FIGS. 9 and 10 has an identical drive structure 44 with a motor 14. The drive structure is connected to three crown-shaped cutters 3 in respective shaving heads 4. The cutters 3 each have a plurality of cutting edges 5 that are movable along an inner surface 7 of a screen 6 of the shaving head 4. The screen 6 has hair-receiving openings in the form of slits 8 and holes 9. In operation, stubble or other hairs projecting through the hair-receiving openings 8, 9 are cut off by the cutting edges 5 of the cutters 3 moving along the inner surfaces 7 of the screens 6 of the shaving heads 4.

The shaving heads 4 are suspended in a shaving head holder 10. The shaving head holder 10 is provided in the form of a hood that is pivotable relative to the housing into an open position (as shown for a different embodiment including the same shaving head holder 10 in FIG. 9) after the release of a locking pawl 12 (see FIG. 9). Pushing a knob 11 arranged at the outside of the housing 2 operates this locking pawl 12. A hair chamber 13 (see FIG. 9) is located between the hair-receiving openings 8, 9 and the housing 2.

The shaver 1 is further provided with liquid displacement impellers 15 for displacing liquid through the hair chamber. According to this example, the liquid displacement impellers 15 are connected via the cutters 3 to the drive structure 44 for driving the movement of the impellers 15.

The number and shape of the impeller blades 16 of the impellers 15 are specifically adapted for effectively displacing liquid, taking into account the available motor power and the transmission ratio of the drive structure 44. More specifically, to achieve a particularly strong pumping effect, the liquid impellers 15 according to the present example have spiral-shaped blades 16. The blades 16 are curved outwardly in a sense contrary to the sense of rotation (arrow 17) when the impellers are in operation. Furthermore, the interspaces between successive blades 16 are axially bounded in one direction by disc-shaped flanges of the rotors 16. In the opposite axial direction, walls of the shaving heads bound the portions of the interspaces radially outside entry ports 19. These features help to prevent or at least counteract a flow of liquid about axial edges of the blades 16 and enable axially narrow blades to effectively pump through the supplied liquid.

The entry ports 19 form flushing passages via which the hair chamber 13 communicates with the environment.

In operation, the liquid displacement impellers 15 generate a vigorous liquid flow in the hair chamber when liquid is supplied to the liquid impellers 15. According to the present example, the liquid impellers 15 throw most of the liquid supplied to the impellers radially outward into the portions of the hair chamber 13 inside the screen 6 of the shaving heads 4. This causes the shaving heads 4 and in particular the cutters 3, that have cutting edges 5 arranged along the outside of the impellers 15, to be cleaned particularly effectively. A regular spraying of liquid against the cutters 3 as caused by the impellers 15 is particularly advantageous if, as in the present example, the cutters 3 are each provided with a plurality of multiple cutting edges which need to be easily movable relative to each other to generate a double-action shaving effect in which hairs are first pulled by a first cutting edge and then cut off by the second cutting edge directly following the first cutting edge. Easy movability is reliably ensured by the intensive cleaning of the pairs of first and second cutting edges, each forming one of a plurality of double-action blades of the cutter 3, even if a shaving lotion is used of which dried up residues could clog up the cutters 3.

During cleaning, the impellers 15 displace liquid fed to the impellers 15 radially outward away from the respective axes of rotation of the impellers 15. Part of the displaced liquid exits the hair chamber via the hair-receiving apertures 8, 9 of the respective shaving heads 4, so that whiskers, hair dust and the like are expelled via a very short route. The rest of the liquid displaced by the impellers 15 is displaced in a direction away from the screens 6 so that other portions of the hair chamber 13 are also rinsed intensively. Depending on the extent to which the hair chamber 13 is filled with liquid, the cleaning effect of the liquid being displaced through the hair chamber is achieved by a spraying effect or by the velocity of the liquid flow forced through the hair chamber.

During shaving, no or at least no significant amount of liquid is fed to the impellers 15. Since the impellers 15 are adapted for displacing liquid, the impellers 15 do not cause significant amounts of airflow, and the normally undesirable effects associated therewith, such as noise, resistance, and spreading of hair particles during shaving, are reduced to a minimum.

To even further reduce air displacement during shaving by the impellers, it is also possible to provide means for not driving the impellers during shaving or to design the impellers for operation at higher rotational speed than the rotational speed of the impellers during shaving and to adapt the drive structure for operation at a shaving speed and a cleaning speed higher than the shaving speed, the speeds being selectable by control members or in response to the presence or absence of liquid fed to the impeller or impellers as sensed by the shaver.

Liquid that has been displaced through the hair chamber 13 exits the hair chamber 13 via an exit port 18. In the present context, flushing passages are passages provided in addition to other passages via which a hair chamber conventionally communicates with the environment, such as the hair-receiving openings 8, 9.

Since the shaver 1 has more than one flushing passage 18, 19, via each of which the hair chamber 13 communicates with the environment, liquid can enter the hair chamber 13 in various positions, and/or separate entry and/or exit passages allow a continuous flow through the hair chambers, so that the hair chamber can be cleaned intensively.

In the shaver 1 according to the present example, the impellers 15 are located directly behind the liquid entry ports 19 so that the impellers 15 are each very effective for displacing liquid through the respective flushing passages 19 behind which they are located and accordingly also for urging liquid outward through the exit port 18, so that a high flow rate through the hair chamber is ensured.

The location of the impellers 15 in the shaving heads 4 is advantageous for various reasons. Firstly, a compact construction is achieved, because the impellers 15 are accommodated in a free space in the shaving heads 4. Secondly, the location of the impellers 15 in the shaving heads 4 results in a very vigorous liquid flow in the shaving heads 4 towards the outer ring of the shaving heads 4, where caking of dirt tends to be most difficult to remove. Thirdly, the location in the shaving heads 4 is closely adjacent the cutters 3, so that it requires few additional measures to adapt the drive structure for driving the cutters 3 for also driving the impellers 5. According to the present example, the liquid displacement impellers 15 are each fixedly and directly connected to one of the cutters 3.

The impellers 15 are furthermore each arranged concentrically inside cutter 3 for displacing liquid against the respective one of the cutters 3. Thus, the cutters 3 are cleaned particularly effectively. This position of the impellers 15 is also advantageous for driving the impellers 15 with the same drive structure as the cutters 3.

The liquid entry ports 19 are located in the shaving heads 4 and adjacent to the hair-receiving openings 8, 9 so that liquid intake for cleaning the hair chamber can easily be combined with rinsing of the outside of the shaving heads 4 and the shaving head holder 10. The liquid entry ports 19 are furthermore arranged between spokes extending radially towards a central hub 20. The hubs 20 form suspensions for keeping the impellers 15 and the cutters 3 centered in the shaving heads 4. Depending on the design of the shaving head, however, the cutters 3 and the impellers 15 may also be suspended to some extent freely floating in the shaving heads or be centered in other manners, for example by guides along the outside of the cutters. The spokes 20 may be of various designs, such as curved spokes, throwing star shaped spokes, mutually crossing spokes etc. and are also advantageous for keeping the skin of the user clear from the impellers 15.

Testing of a shaver according to the present example has shown that a shaving unit polluted with shaving debris and human skin grease is usually cleaned within about 10 seconds using water from a tap as the liquid and without opening the hair chamber 13. The water may be supplied in a simple manner by holding the portion of the shaver containing the entry ports 19 in a flow of water running from a tap or in water in for instance a bowl or glass. It is also possible to supply cleaning agents, for example in concentrated form, prior to the water supply or dissolved in water that is supplied via the entry ports 19.

FIGS. 4 to 6 show a second shaver 101 according to the invention. In this shaver 101, the shaving head holder 110 is detachable from a hair chamber bowl portion 121 of the housing 102. The shaving heads 104 are of a design different from the shaving heads 4 of the shaver 1 shown in FIGS. 1 to 3. However, it is also possible to provide a shaver 102 as shown in FIGS. 4 to 6 with shaving heads identical or similar to the shaving heads 4 of the shaver 1 shown in FIGS. 1 to 3.

In the shaver 101 according to the present example, the impellers 115 are arranged in flushing passages 122, 123, 124 of a flushing channel structure 118, which allows the impellers 115 to displace liquid effectively through the flushing passages 122, 123, 124.

The effectiveness of the impellers 115 is further enhanced, because the impellers 115 are arranged in pump chambers 127 for displacing liquid through the pump chambers 127 and are movable closely along walls 128, 129 of the pump chamber 127.

The impellers 115 have blades 116 and are axially open towards the hair chamber 113 for axial liquid intake and axially closed at the side facing away from the hair chamber 113, which is advantageous for forcing the liquid radially outward without leakage at the side facing away from the hair chamber where no axial passage of liquid is required.

The impellers 115 are arranged downstream of the hair chamber 113 for pumping liquid from the hair chamber 113 (arrow 141). This is particularly advantageous for displacing special cleaning liquids such as alcohol that are to be collected, for example for recirculation or later re-use, through the hair chamber 113, because an underpressure is generated in the hair chamber 113, so that escape of cleaning liquids from the hair chamber via openings other than the exit passages 122 123 and 124 is counteracted.

The flushing passage 122, 123, 124 in which the impellers 115 are located have entry areas arranged around drive shafts 125 for driving the cutters into rotation in the shaving heads 104, so that the liquid can be discharged axially along the drive shafts (arrows 142) and hair and skin particles accumulated at the foot of the stubs of the drive shafts 125 projecting into the hair chamber 113 are effectively flushed away.

As shown in FIG. 5, the motorized drive structure 125 for driving the movement of the cutters 3 along the internal surfaces 7 of the screen 6 are also connected to the impellers 115 for driving the motion of the impellers 115, so that the same drive structure drives both the cutters 3 and the impellers 115. In combination with the feature that the flushing passages 122, 123, 124 in which the impellers 115 are located have entry areas arranged around drive shafts 125, this further provides the advantage that the drive shafts only need to be sealed against the housing 102 in one position along the shaft. Moreover, each of the impellers 115 is suspended for rotation about a common axis of rotation 126 together with one of the cutters 3, so that a very simple construction is obtained.

The liquid inlet port 119 of the shaver 101 according to FIGS. 4 to 6 is located at a side of the hair chamber 113 that faces in substantially the same direction as the direction in which the housing 102 projects most from the shaving head holder 110. This renders it possible for liquid, for example liquid pouring down from a tap, to flow into the hair chamber 113 (arrow 143) while the shaver 101 is held in an orientation with the end of the shaver 101 where the shaving heads 104 are located held downward, so that no or very little liquid flows over the user's hand. The exit port of the flushing passages 122, 123, 124 then points obliquely sideways and downward, so that liquid that is urged out of the hair chamber does not spray far away from the shaver 101.

The shaver 201 shown in FIGS. 7 and 8 is also equipped with impellers 215 in a flushing channel structure 219 with flushing passages 230-233. The blades 216 of the impellers 215 are arranged in pump chambers 227. Outlet ports or orifices 234-236 communicate with the pump chambers 227.

The impellers 215 are arranged upstream of the hair chamber 213 for pumping liquid into the hair chamber 213. This is advantageous because it propels liquid jets into the hair chamber 213, which jets are particularly effective for removing shaving debris that adheres to surfaces in the hair chamber. The liquid jets may be directly aimed at surfaces from which shaving debris is to be removed, but may also be used to create liquid turbulence or circulation in the hair chamber.

The hair chamber 213 has a peripheral wall 237 bounding the hair chamber 213 along a contour about the shaving heads 104. The outlet ports 234-236 of the flushing passages 231-233 in which the impellers 215 are located are directed closely along the peripheral wall 237 extending around the hair chamber 213 along its contour in plan view along the axes 126 of the shaving heads 104 and the drive shafts 125. This causes liquid that is forced into the hair chamber 213 by the impellers 215 to be jetted along the wall 237, so that the cleaning effect of the liquid is distributed in circumferential sense of the wall 237.

Furthermore, the outlet ports 234-236 are directed in a common sense of circulation indicated by arrows 238 in FIG. 7. This causes the injected liquid to be circulated vigorously along the peripheral wall 237, so that a particularly effective cleaning effect is achieved.

The liquid that has been forced into the hair chamber 231 is finally forced out of the hair chamber via the shaving heads 104, so that the interior of the shaving heads and the cutters 3 are also cleaned effectively.

The shaver 301 according to the invention shown in FIGS. 9 and 10 is equipped with impellers 315 located in the hair chamber 313 for displacing liquid inside the hair chamber 313. During cleaning, the impellers 315 agitate the liquid inside the hair chamber, causing the liquid to whirl and/or splash against internal surfaces inside the hair chamber 313, thereby entraining hair and skin particles from those surfaces in the hair chamber 313.

For feeding liquid into the hair chamber 313 (arrow 339), the hair chamber 313 communicates with the environment via a relatively large flushing passage 319 at one side of the hair chamber 313 and a relatively small flushing passage 318 at an opposite side of the hair chamber 313 for draining liquid from the hair chamber 313 (arrow 340). For cleaning, the shaver 301 is switched on and liquid is fed via the large flushing passage 319, for example in that the large flushing passage is held in a stream of liquid flowing from a tap connected to the liquid mains. Liquid entering the hair chamber 313 is vigorously agitated by the impellers 315 and continuously flows from the hair chamber 313 via the drainage port 318. Preferably, the liquid is supplied at a rate that exceeds the rate at which liquid can flow from the hair chamber 313 until the hair chamber 313 is completely filled with liquid, whereupon the chamber is drained. The agitation of the liquid in the hair chamber 313 then gradually changes from a condition in which the liquid is splashed through the hair chamber 313 to a condition in which the liquid is whirled through the hair chamber 313 and back, which is advantageous for obtaining a uniform cleaning effect.

Closures in the form of plugs 345, 346 are provided for closing off the flushing passages 318, 319 during shaving, so that the escape of shaving debris during shaving is reduced. The plugs 345, 346 are displaceable between a closed position (as shown) for closing off the flushing passages and an open position for allowing liquid to pass through the flushing passages. In the latter position, the plugs 345, 346 remain connected to the shaving head holder by integrally formed strips 347, 348 that are anchored to the shaving head holder, so that the plugs 345, 346 cannot get lost. Closures for closing off flushing passages may be provided in many other forms, for example in the form of hinged or sliding panels.

For effectively cleaning the hair chamber, it is also advantageous that the impellers 315 are connected to the drive structure 14, 125 for driving the impellers 315 in a common sense of rotation. This causes the liquid in the hair chamber to circulate in that sense of circulation and thereby causes an intensive cleaning effect.

It is observed that many embodiments of the present invention other than those shown and described are possible, for example, the impellers for displacing liquid may be of various other designs and provided in other numbers, and impellers pumping liquid into and out of the hair chamber via various passages as well as impellers displacing liquid inside the hair chamber may be combined. Furthermore, the shaving head does not need to be of a design with a rotary cutter, but other designs, for example with oscillating cutters and with liquid displacement impellers for displacing liquid through the hair chamber are also conceivable. Furthermore, the drive structure for driving the impeller or impellers may be coupled to the same motor as the shaving cutter or cutters, but it is also possible to provide that the shaver is equipped with separate motors for shaving and for driving the liquid displacement impellers.

1. A shaver including:
a shaving head holder (10, 110) carrying at least one shaving head (4; 104) comprising a screen (6) having an internal surface (7), an external surface for contacting a skin to be shaved, and hair-receiving openings (8, 9), and at least one cutter (3) having at least one cutting edge (5) movable along the internal surface (7) of the screen (6), the at least one cutting edge (5) cooperating with the screen (6) for cutting off hairs projecting through the hair-receiving openings (8, 9);
a hair chamber (13; 113; 213; 313) behind the hair-receiving openings (8, 9);
a drive structure (44; 125) comprising at least one motor (14); and
at least one liquid displacement impeller (15; 115; 215; 315) for displacing liquid through the hair chamber (13; 113; 213; 313), the at least one liquid displacement impeller (15; 115; 215; 315) being connected to the drive structure (44; 125) for driving the movement of the impeller (15; 115; 215; 315).

2. A shaver according to claim 1, wherein the drive structure (44; 125) for driving the movement of the at least one impeller (15; 115; 215; 315) is also connected to the at least one cutter (3) for driving the motion of the cutter (3) along the internal surface (7) of the screen (6).

3. A shaver according to claim 1 or 2, wherein the impeller or at least one of the impellers (15; 115; 215; 315) and the cutter or at least one of the cutters is suspended for rotation about at least one common axis of rotation (126).

4. A shaver according to any one of the preceding claims, wherein the at least one impeller (15; 115; 215; 315) is arranged in a pump chamber (127; 227) for displacing liquid through the pump chamber (127; 227) and is movable closely along at least one wall (128, 129) of the pump chamber (127; 227).

5. A shaver according to any one of the preceding claims, further comprising at least one flushing passage (18, 19; 118, 122-124; 219, 230-236; 318, 319) via which the hair chamber (13; 113; 213; 313) communicates with the environment.

6. A shaver according to claim 5, further comprising at least two flushing passages (18, 19; 118, 122-124; 219, 230-236; 318, 319) via each of which the hair chamber (13; 113; 213; 313) communicates with the environment

7. A shaver according to claim 5 or 6, wherein the impeller or at least one of the impellers (15; 115; 215; 315) is arranged for displacing liquid through the at least one flushing passage (18, 19; 118, 122-124; 219, 230-236).

8. A shaver according to claim 7, wherein the impeller or at least one of the impellers (15; 115; 215; 315) is arranged in the at least one flushing passage (118, 122-124; 231-233).

9. A shaver according to claim 8, wherein the impeller or at least one of the impellers (115) is arranged for pumping liquid out of the hair chamber (113).

10. A shaver according to claim 9, wherein the at least one flushing passage (122-124) in which the impeller or at least one of the impellers (115) is located has at least one entry area arranged around a drive shaft (125) for driving the at least one cutter (3) into rotation.

11. A shaver according to any one of the claims 8 to 10, wherein the impeller or at least one of the impellers (215) is arranged for pumping liquid into the hair chamber (213).

12. A shaver according to claim 11, wherein the hair chamber (213) has at least one peripheral wall (237) bounding the hair chamber (213) along a contour about the at least one shaving head (4; 104), and the at least one flushing passage (231-233) in which the or at least one of the impellers (215) is located has an exit orifice (234-236) aimed closely along the peripheral wall (237) of the hair chamber (213).

13. A shaver according to claim 12, comprising a plurality of said exit orifices (234-236) directed so as to achieve a common sense of circulation.

14. A shaver according to any one of the claims 5 to 13, further comprising at least one closure (345, 346) for closing off the flushing passage or at least one of the flushing passages (318, 319), the at least one closure (345, 346) being displaceable between a closed position for closing off the at least one flushing passage (318, 319) and an open position for allowing liquid to pass through the at least one flushing passage (318, 319).

15. A shaver according to any one of the preceding claims, wherein the flushing passage or at least one of the flushing passages (19) is located in the at least one shaving head (4) and adjacent to the hair-receiving openings (8, 9).

16. A shaver according to claim 15, wherein the at least one impeller (15) is at least partially located in the at least one shaving head (4).

17. A shaver according to claim 16, wherein the at least one impeller (15) is arranged concentrically inside at least a portion of the cutter or at least one of the cutters (3) for displacing liquid against the cutter (3) or at least one of the cutters (3).

18. A shaver according to any one of the preceding claims, wherein the impeller or at least one of the impellers (315) is located in the hair chamber (313) for displacing liquid inside the hair chamber (313).

19. A shaver according to claim 18, comprising at least two of the impellers (315) located in the hair chambers (313), the at least two impellers (315) being connected to a drive structure (44; 125) for driving the at least two impellers (315) in a common sense of rotation.

20. A shaving head (4) comprising:
a screen (6) for bounding a hair chamber (13), the screen (6) having an internal surface (7), an external surface for contacting a skin to be shaved, and hair-receiving openings (8, 9);
at least one cutter (3) having at least one cutting edge (5) movable along the internal surface (7) of the screen (6), the at least one cutting edge (5) cooperating with the screen (6) for cutting off hairs projecting through the hair-receiving openings (8, 9); and
at least one flushing passage (19) closely adjacent the hair-receiving openings for allowing liquid to flow between the chamber and an area outside the chamber.

21. A shaving head according to claim 20, further comprising at least one liquid displacement impeller (15) for displacing liquid through the at least one flushing passage (19).

22. A shaving head according to claim 21, wherein the at least one impeller (15) is arranged concentrically inside at least a portion of the cutter or at least one of the cutters (3) for displacing liquid against the cutter (3) or at least one of the cutters (3).

23. A method of cleaning a hair chamber (13; 113; 213; 313) of a shaver (1; 101; 201; 301), the shaver comprising a shaving head holder carrying at least one shaving head (4; 104) comprising a screen (6) having at least an internal surface (7), an external surface for contacting a skin to be shaved, and hair-receiving openings (8, 9), and at least one cutter (3) having at least one cutting edge (5) movable along the internal surface (7) of the screen (6), the at least one cutting edge (5) cooperating with the screen (6) for cutting off hairs projecting through the hair-receiving openings (8, 9), the hair chamber (13; 113; 213; 313) being located behind the hair-receiving openings (8, 9), wherein liquid is displaced through the hair chamber (13; 113; 213; 313) by at least one liquid displacement impeller (15; 115; 215; 315) driven by a motorized drive structure (4; 125) of the shaver.
